(19) United States
(12) Patent Application Publication
(10) Pub. No.: US 2010/0208371 A1
(43) Pub. Date: Aug. 19, 2010

(54) STRUCTURE FOR CONTROLLING OPTICAL ZOOM DISTANCE VIA MAGNETIC LINES OF FORCE

(76) Inventor: LI-MING CHAO, Taipei City (TW)

Correspondence Address: KILE GOEKJIAN REED & MCMANUS, 1200 NEW HAMPSHIRE AVE, NW, SUITE 570, WASHINGTON, DC, 20036, US

(21) Appl. No.: 12/503,853

(22) Filed: Jul. 16, 2009

(30) Foreign Application Priority Data
Feb. 13, 2009 (TW) 98202114

(51) Int. Cl. G02B 7/04

(52) U.S. Cl. 359/824

(57) ABSTRACT

A structure for controlling optical zoom distance via magnetic lines of force, which is applied in electric torches, lighting lamps and so on, includes a closed shell, a controlled member, a controlling member, a zoom device, a first magnetic element and a second magnetic element. The controlled member is movably disposed in the closed shell. The controlling member is movable disposed outside the closed shell. The zoom device is disposed on the controlled member. The first magnetic element is disposed on the controlled member and the second magnetic element is disposed on the controlling member. Based on the structure, the present invention can achieve optical zoom.

### BACKGROUND OF THE INVENTION

1. Field of the Invention

The present invention relates to an optical zoom distance structure, and more particularly to an optical zoom distance structure which is applied in electric torches, lighting lamps and so on, and controls optical zoom distance via magnetic lines of force.

2. Description of Related Art

Electric torches are one kind of lighting tool and generally divided into two categories: conventional electric torches and variable-focus electric torches. The conventional electric torches have shells formed by combining a bulb housings and a main housing closely, and cannot adjust focusing/defocusing light sources. The variable-focus electric torches can adjust focusing/defocusing light sources. Based on relative movements of the bulb housings and the main housing of the variable-focus electric torches, and front and rear movements of physical optical zoom elements (convex lenses or refraction lamp cups) fixed in the bulb housings, relative displacement is produced between the physical optical zoom elements and the light sources of the electric torches, so light from light sources (such as light-emitting diodes) can be focused after traveling different distances, thereby the light can further be concentrated in small lighting areas. Furthermore, the light can be defocused via moving the bulb housings and the physical optical zoom elements again, so that the light can shine in large lighting areas.

However, electric torches for protecting against liquid and preventing combustible and hazardous gas from being ignited by spark mainly must have the shells formed by combining the bulb housings and the main housing closely, and seal rings made of plastic soft materials disposed in jointing gaps to prevent liquid and hazardous gas from infiltrating into the electric torches. The variable-focus electric torches, having the function of adjusting focusing/defocusing light sources, can also be used as the electric torches for protecting against liquid and preventing combustible and hazardous gas from being ignited by spark. Since the conventional bulb housings have the fixed-type physical optical zoom elements disposed therein, they must be moved far away from the original positions where they are combined with the main housing, if the optical zoom needs to be achieved. Though the conventional electric torches have the seal rings to fill in the gaps produced during movement, there must be active gaps formed between the bulb housings and the seal rings to ensure that the bulb housings can move during optical zoom. Accordingly, if the electric torches is operated carelessly or the seal rings are aged, worn, or there are foreign bodies in the structure, the gaps will occur, so that the liquid or the hazardous gas infiltrates through the active gaps between the bulb housings and the main housing. The liquid will easily cause that inner elements are damaged and short circuits occur; the combustible and hazardous gas will be easily ignited by spark at electric joints.

Therefore, there is a need of a novel invention that overcomes the above disadvantages.

### SUMMARY OF THE INVENTION

A main object of the present invention is to provide a structure for controlling optical zoom distance via magnetic lines of force, which can achieve optical zoom and has the effect of preventing liquid and hazardous gas from infiltrating effectively, and the advantage of convenient operation.

To achieve the above-mentioned object, a structure for controlling optical zoom distance via magnetic lines of force in accordance with the present invention is provided. The structure includes a closed shell; a controlled member movably disposed in the closed shell; a controlling member movable disposed outside the closed shell, corresponding to the controlled member; a zoom device disposed on the controlled member; at least one first magnetic element, disposed on the controlled member; and at least one second nagnetic element, disposed on the controlling member, wherein the second magnetic element and the first magnetic element can selectively produce corresponding magnetic lines of force to drive the controlled member to drive the zoom device to move in the closed shell.

The present invention can drive the second magnetic element to attract or repel the first magnetic element based on the movement of the controlling member. And under the interaction of the magnetic lines of force, the physical optical zoom device can move to keep different distances from the light source, thereby achieving the optical zoom. Based on the design, the controlled member and the zoom device needed to be moved are concealed in the closed shell, so the present invention has the effect of preventing liquid and hazardous gas from seeping effectively, and the advantage of convenient operation.

To further understand features and technical contents of the present invention, please refer to the following detailed description and drawings related the present invention. However, the drawings are only to be used as references and explanations, not to limit the present invention.

### BRIEF DESCRIPTION OF THE DRAWINGS

FIG. 1 is an assembled perspective view of a structure for controlling optical zoom distance via magnetic lines of force of the present invention;

FIG. 2 is an exploded perspective view of the structure for controlling optical zoom distance via magnetic lines of force of the present invention;

FIG. 3 is a cross-sectional assembled view of the structure for controlling optical zoom distance via magnetic lines of force of the present invention;

FIG. 4 is a cross-sectional assembled view of the structure for controlling optical zoom distance via magnetic lines of force of the present invention, showing that a controlling member is in a rotation state;

FIG. 4A is another cross-sectional assembled view of the structure for controlling optical zoom distance via magnetic lines of force of the present invention, showing that the controlling member is in the rotation state;

FIG. 5 is a cross-sectional assembled view of the structure for controlling optical zoom distance via magnetic lines of force of the present invention, showing that the controlling member is in a front and rear movement state;

FIG. 6 is another exploded perspective view of the structure for controlling optical zoom distance via magnetic lines of force of the present invention;

FIG. 6A is a planar view of the structure for controlling optical zoom distance via magnetic lines of force of the present invention, showing the change of the distance between a refraction lamp cup and a light source;

FIG. 7 is a cross-sectional assembled view of another embodiment of the structure for controlling optical zoom distance via magnetic lines of force of the present invention; and

FIG. 8 is a cross-sectional assembled view of another embodiment of the structure for controlling optical zoom distance via magnetic lines of force of the present invention.

### DETAILED DESCRIPTION OF THE PREFERRED EMBODIMENTS

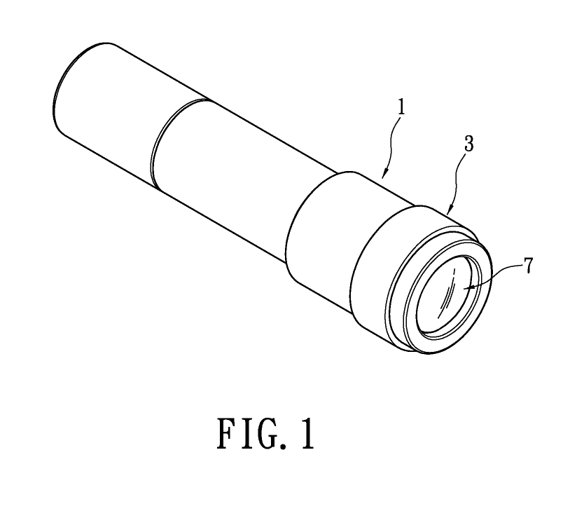

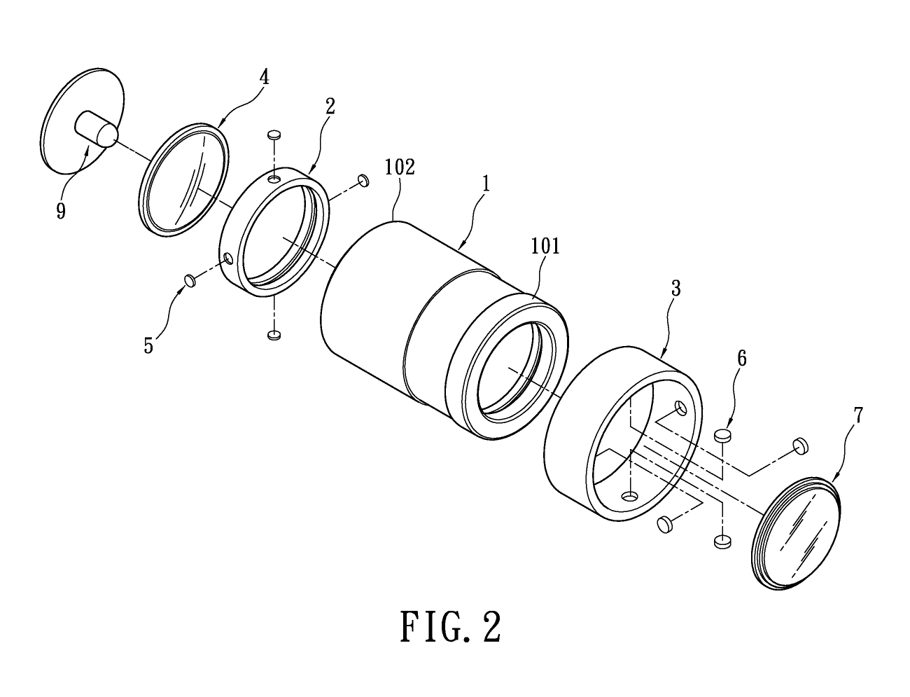

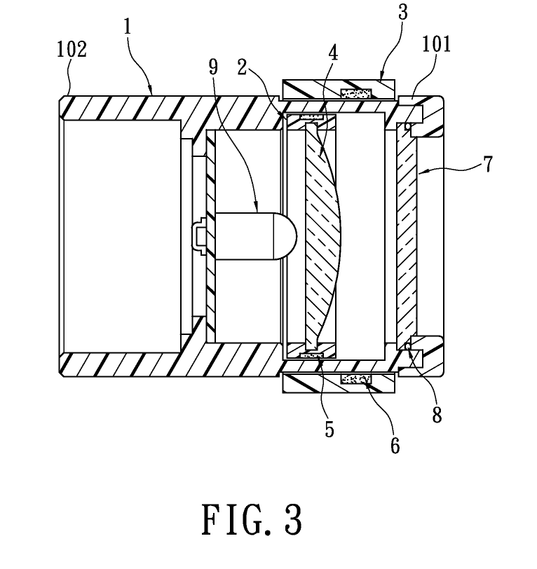

Please refer to FIGS. 1-3 illustrating a structure for controlling optical zoom distance via magnetic lines of force according to the present invention, which may be applied in optical zoom devices such as electric torches, lighting lamps and so on. In the embodiment, the structure is used in an electric torch. The structure includes a closed shell 1, a controlled member 2, a controlling member 3, a zoom device 4, at least one first magnetic element 5 and at least one second magnetic element 6.

The closed shell 1 is one portion of a main body of the electric torch, and the closed shell 1 forms the portion of the main body of the electric torch via assembly or integral forming. The closed shell 1 has at least one light source 9 disposed therein, which may be a visible light emitting diode (LED), a bulb or an invisible light emitting diode, etc. A lens 7 and a seal ring made of a plastic soft material 8 are disposed in a front end 101 of the main body of the electric torch; an electric source (not shown), such as dry batteries, rechargeable batteries, or storage batteries, is disposed in a rear end 102 of the main body of the electric torch. The electric source and the light source 9 are connected via proper conductive elements (not shown) to form a loop, so that the electric power from the electric source can be transmitted into the light source 9, thereby supplying desired electric energy for the light source 9. Since the electric torch generally has the same structure as the prior art, which isn't an emphasis of the present invention, detailed descriptions of the electric torch are omitted inhere.

The closed shell 1 is a hollow shell which isn't limited in shape. In the embodiment, the closed shell 1 is a circular hollow shell. The closed shell 1 has two opposite ends which are respectively the front end 101 and the rear end 102. The lens 7 is disposed in the front end 101 of the closed shell 1. In the embodiment, the lens 7 is a lens which can protect liquid and hazardous gas from entering the electric torch.

The controlled member 2 is a hollow body. In the embodiment, the controlled member 2 is a circular hollow body, corresponding to the inner wall of the closed shell 1. The controlled member 2 is disposed in the closed shell 1, and may move front and rear in the closed shell 1. The controlled member 2 may move in the axial direction (that is, the front and rear direction) of the closed shell 1, so as to drive the zoom device 4 to approach or leave the lens 7.

The controlling member 3 is a hollow body. In the embodiment, the controlling member 3 is a circular hollow body, corresponding to the outer wall of the closed shell 1. The controlling member 3 movably surrounds the closed shell 1, corresponding to the controlled member 2 located in the closed shell 1.

The zoom device 4 may be an optical lens or a refraction lamp cup etc. In the embodiment, the zoom device 4 is an optical lens. The zoom device 4 is fixed on the controlled member 2, so that the zoom device 4 can be moved simultaneously with the controlled member 2 and keep different distances from the light source 9, thereby achieving optical zoom.

The embodiment further includes one or a plurality of first magnetic elements 5, and one or a plurality of second magnetic elements 6. The first magnetic elements 5 may be magnets or iron pieces, and the first magnetic elements 5 are an integral element, or separated into a plurality of spaced elements disposed on the controlled member 2. The second magnetic elements 6 may be magnets or iron pieces, and the second magnetic elements 6 are an integral element or separated into a plurality of spaced elements disposed on the controlling member 3.

If the first magnetic elements 5 and the second magnetic elements 6 all are magnets, then an end face of the first magnetic elements 5 and an end face of the second magnetic elements 6, which the two end faces are adjacent to each other, may be the magnetic poles with the same magnetism, or opposite magnetisms. Therefore the first magnetic elements 5 and the second magnetic elements 5 can produce magnetic lines of force and attract or repel each other. If the first magnetic elements 5 or the second magnetic elements 6 are magnets, the other are iron pieces, then the first magnetic elements 5 and the second magnetic elements 5 only can attract each other.

Based on the movement of the controlling member 3 disposed outside the closed shell 1 (such as rotation or front and rear movement), the second magnetic elements 6 disposed on the controlling member 3 and the first magnetic elements 5 disposed on the controlled member 2 can attract or repel each other. Due to the effect of the magnetic lines of force, the controlled member 2 can move in the closed shell 1, the zoom device 4 fixed on the controlled member 2 is moved with the controlled member 2, to correspond to the light source 9. Therefore the light from the light source 9 of the electric torch can be focused or defocused after traveling the movement distance of the zoom device 4.

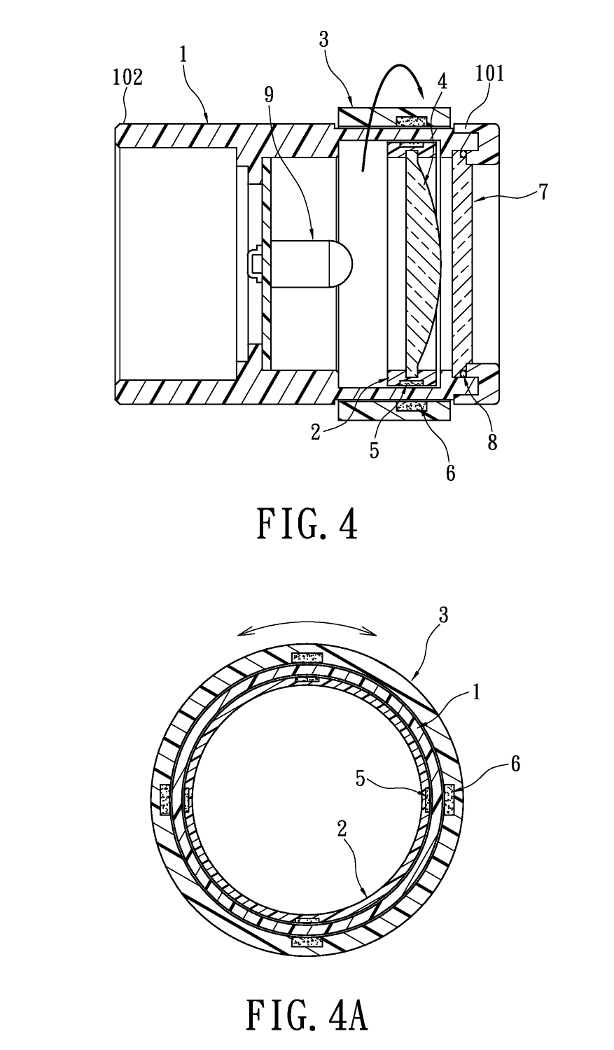

As shown in FIG. 4 and FIG. 4A, in the embodiment, the controlling member 3 rotatably surrounds the closed shell 1. The first magnetic elements 5 and the second magnetic elements 6 are magnets repelling each other. When the controlling member 3 isn't rotated, the controlled member 2 is located at a first position; when the controlling member 3 is rotated to a proper angle, the controlled member 2 and the zoom device 4 can move forwards or rearwards to a second position under the repelling effect of the first magnetic elements 5 and the second magnetic elements 6; when the controlling member 3 is rotated again to a proper angle, the controlled member 2 and the zoom device 4 can move from the second position to the first position, thereby achieving the optical zoom (focusing/defocusing).

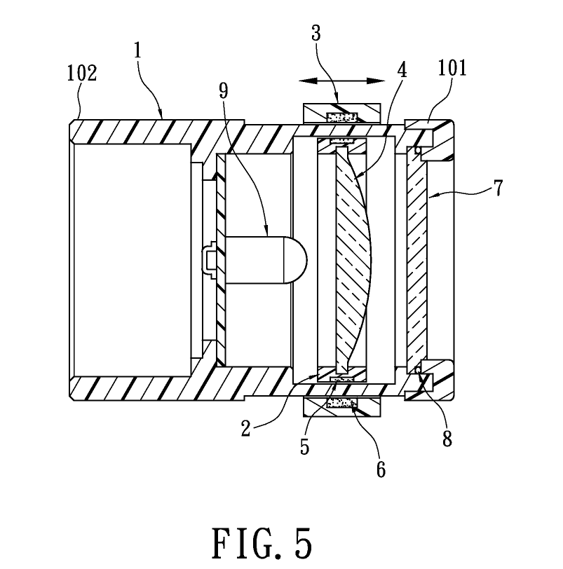

As shown in FIG. 5, in the embodiment, the controlling member 3 surrounds the closed shell 1 movably front and rear. The first magnetic elements 5 and the second magnetic elements 6 are magnets attracting each other. When the controlling member 3 isn't moved, the controlled member 2 is located at the first position; when the controlling member 3 is moved to a proper position, under the attraction effect of the first magnetic elements 5 and the second magnetic elements 6, the controlled member 2 and the zoom device 4 can move forwards or rearwards to the second position; when the controlling member 3 is moved to its original position, the controlled member 2 and the zoom device 4 can move from the second position to the first position, thereby achieving the optical zoom (focusing/defocusing).

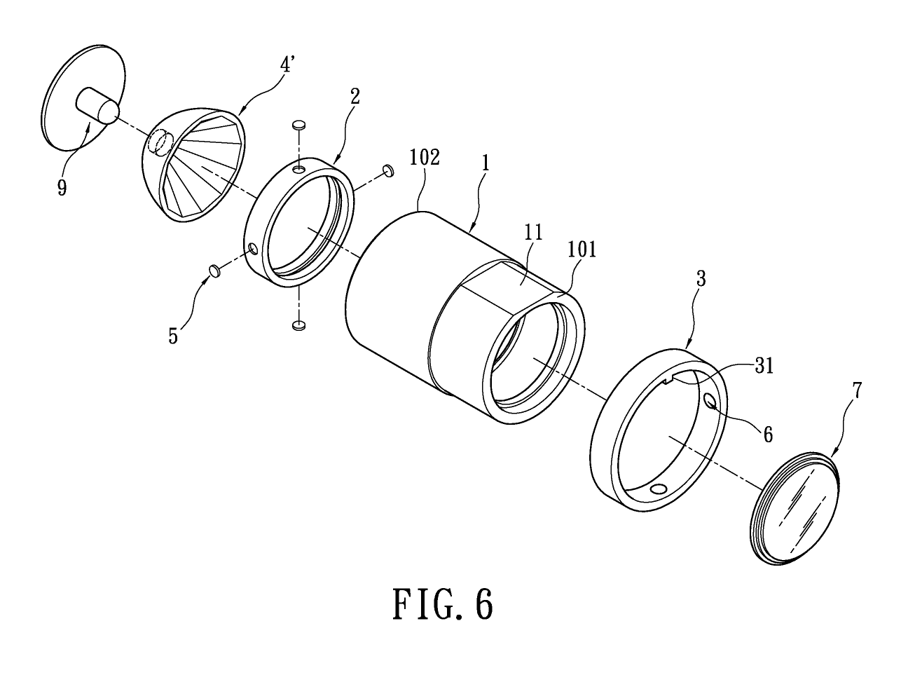

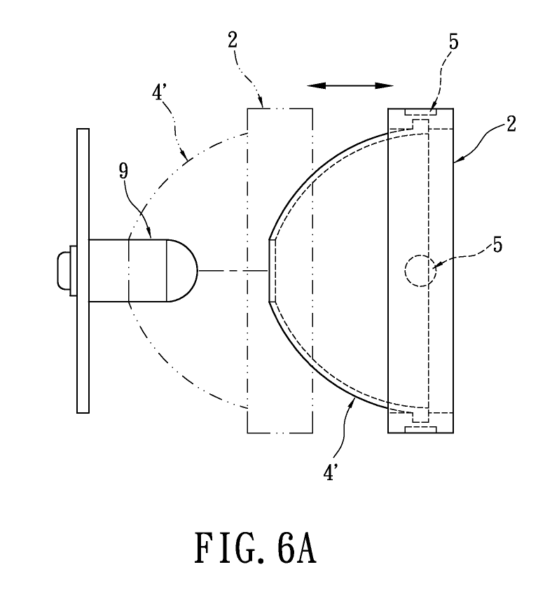

The zoom device described above may have different structure designs, as shown in FIG. 6 and FIG. 6A, a zoom device 4′ is a refraction lamp cup. The refraction lamp cup may be an independent element which is assembled on the controlled member 2; alternatively, the refraction lamp cup may also be integrally formed with the controlled member 2. The refraction lamp cup has an optical refractive effect, so the optical zoom can be achieved when the distance between the refraction lamp cup and the light source 9 is changed.

As shown in FIG. 6, in the embodiment, one portion of the closed shell 1, corresponding to the movement of the controlling member 3, is a circular hollow body. When the controlling member 3 surrounds the closed shell 1 movably front and rear, the closed shell 1 may has a blocking face 11 formed on the outer wall of the closed shell 1, and the controlling member 3 may has a blocking element 31 protruding from the inner wall of the controlling member 3, corresponding to the blocking face 11 of the closed shell 1. Because two sides of the blocking face 11 can stop the blocking element 31, so the blocking face 11 and the block element 31 can overlap via rotation, which can limit the movement of the controlling member 3 and the second magnetic elements 6, so that the controlling member 3 and the second magnetic elements 6 are positioned at a special position during the front and rear movement. At this time, the first magnetic elements 5 disposed on the controlled member 2 in the closed shell 1 are correspondingly positioned at a special position based on magnetic attraction; the zoom device 4 disposed on the controlled member 2 and the light source 9 also are fixed in a special optical zoom distance.

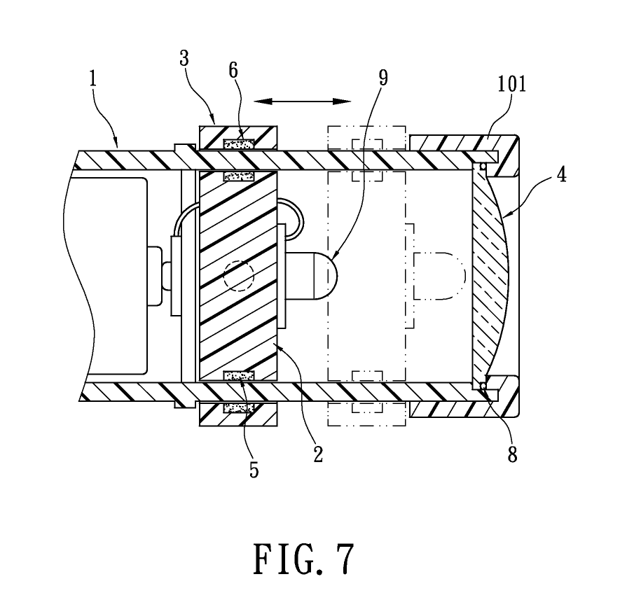

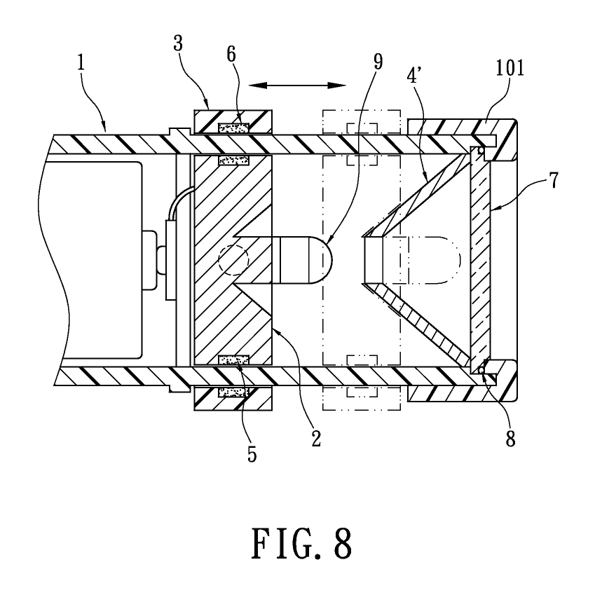

As shown in FIG. 7 and FIG. 8, in the embodiment, the light source 9 is disposed on the controlled member 2, and the zoom devices 4, 4′ are disposed in the closed shell 1 in a fixed way. The zoom device 4 may be a fixed-type optical lens (as shown in FIG. 7), and the zoom device 4′ may also be a refraction lamp cup (as shown in FIG. 8). The zoom devices 4, 4′ are fixed in the closed shell 1. The light source 9 and the controlled member 2 move jointly to produce different distances from the zoom devices 4, 4′, thereby achieving the optical zoom effect.

Consequently, based on the movement of the controlling member 3 disposed outside the closed shell 1 (such as rotation or front and rear movement), the present invention can drive the second magnetic elements 6 to selectively have a corresponding effect of magnetic lines of force on the first magnetic elements 5 disposed in the closed shell 1, further to drive the controlled member 2 to drive the zoom devices 4, 4′ (or the light source 9) to move in the closed shell 1, thereby achieving the optical zoom effect. Based on the design, the controlled member 2 and the zoom devices 4, 4′ needed to be moved are concealed in the closed shell 1, so the present invention has the effect of protecting against liquid and preventing combustible and hazardous gas from being ignited by spark effectively, and is suitable for liquid applications, combustible and hazardous gas applications and so on. Furthermore, the light source and zoom structure is disposed in the closed shell 1, so the present invention won't be influenced by environmental factors (such as pressure and pollution) outside the closed shell 1 and has the advantage of convenient operation.

What are disclosed above are only the specification and the drawings of the preferred embodiments of the present invention and it is therefore not intended that the present invention be limited to the particular embodiments disclosed. It will be understood by those skilled in the art that various equivalent changes may be made depending on the specification and the drawings of the present invention without departing from the scope of the present invention.

What is claimed is:

1. A structure for controlling optical zoom distance via magnetic lines of force, comprising:
a closed shell;
a controlled member, movably disposed in the closed shell;
a controlling member, movable disposed outside the closed shell, corresponding to the controlled member;
a zoom device, disposed on the controlled member;
at least one first magnetic element, disposed on the controlled member; and
at least one second magnetic element, disposed on the controlling member, wherein the second magnetic element and the first magnetic element can selectively produce corresponding magnetic lines of force to drive the controlled member to drive the zoom device to move in the closed shell.

2. The structure as claimed in claim 1, wherein the closed shell has a light source disposed therein.

3. The structure as claimed in claim 1, wherein the controlling member rotatably surrounds the closed shell.

4. The structure as claimed in claim 1, wherein the controlling member movably surrounds the closed shell.

5. The structure as claimed in claim 4, wherein one portion of the closed shell, corresponding to movement of the controlling member, is a circular hollow body; and the closed shell has a blocking face formed on an outer wall thereof, the controlling member has a blocking element protruding from an inner wall thereof, corresponding to the blocking face.

6. The structure as claimed in claim 1, wherein the zoom device is a lens.

7. The structure as claimed in claim 1, wherein the zoom device is a refraction lamp cup.

8. The structure as claimed in claim 1, wherein the first magnetic element and the second magnetic element are magnets.

9. The structure as claimed in claim 8, wherein an end face of the first magnetic element and an end face of the second magnetic element, which are adjacent to each other, are magnetic poles with opposite magnetisms.

10. The structure as claimed in claim 8, wherein an end face of the first magnetic element and an end face of the second magnetic element, which are adjacent to each other, are magnetic poles with the same magnetism.

11. The structure as claimed in claim 1, wherein the first magnetic element is a magnet, the second magnetic element is an iron piece.

12. The structure as claimed in claim 1, wherein the first magnetic element is an iron piece, the second magnetic element is a magnet.

13. A structure for controlling optical zoom distance via magnetic lines of force, comprising:
a closed shell;
a controlled member, movably disposed in the closed shell;
a controlling member, movable disposed outside the closed shell, corresponding to the controlled member;
a light source, disposed on the controlled member;
a zoom device, disposed on the closed shell;
at least one first magnetic element, disposed on the controlled member; and
at least one second magnetic element, disposed on the controlling member, wherein the second magnetic element and the first magnetic element can selectively produce corresponding magnetic lines of force to drive the controlled member to drive the light source to move in the closed shell.

14. The structure as claimed in claim 13, wherein the controlling member rotatably surrounds the closed shell.

15. The structure as claimed in claim 13, wherein the controlling member movably surrounds the closed shell.

16. The structure as claimed in claim 13, wherein the zoom device is a lens.

17. The structure as claimed in claim 13, wherein the zoom device is a refraction lamp cup.
